(19) United States
(12) Patent Application Publication
(10) Pub. No.: US 2026/0300630 A1
(43) Pub. Date: Oct. 1, 2026

(54) PERPLEXITY-BASED PROMPT GENERATION FOR COMMUNICATION STYLES

(71) Applicant: International Business Machines Corporation, Armonk, NY (US)

(72) Inventor: Bo WEN, Chappaqua, NY (US)

(21) Appl. No.: 19/095,323

(22) Filed: Mar. 31, 2025

(51) Int. Cl. G06F 40/30; G06F 16/3329; G06N 20/00

(52) U.S. Cl. CPC G06F 40/30; G06F 16/3329; G06N 20/00

(57) ABSTRACT

In some implementations, a device may generate, based on different large-language models (LLMs), prompts that are diverse. The device may adjust a level of perplexity in the generated prompts to correspond to one or more communication styles of a target population.

### BACKGROUND

This disclosure generally relates to natural language processing, and more specifically, to perplexity-based prompt generation for communication styles. Different populations can have different communication styles.

### SUMMARY

Some aspects described herein relate to a method. The method may include generating, based on different large-language models (LLMs), prompts that are diverse. The method may include adjusting a level of perplexity in the generated prompts to correspond to one or more communication styles of a target population.

Some aspects described herein relate to a computer system. The computer system may include a processor set, one or more computer-readable storage media, and program instructions stored on the one or more computer-readable storage media to cause the processor set to perform operations. The operations may include generating diverse prompts. The operations may include adjusting a level of perplexity in the diverse prompts to match a communication style of a target patient population. The operations may include filtering the diverse prompts based on a comparison of the diverse prompts to linguistic characteristics of observed patient communications of the target patient population.

Some aspects described herein relate to a computer program product. The computer program product may include one or more computer-readable storage media and program instructions stored on the one or more computer-readable storage media to perform operations. The operations may include receiving a target perplexity value associated with a communication style of a patient population. The operations may include generating diverse and unique prompts using multiple LLMs having a level of perplexity that corresponds to the target perplexity value. The operations may include analyzing the prompts using patient communication datasets and psycholinguistic information of the patient population.

### BRIEF DESCRIPTION OF THE DRAWINGS

FIG. 1 is a diagram of an example computing environment for adjusting a perplexity of prompts as described herein.

FIG. 2 is a diagram illustrating an implementation of a high-level architecture of a language synthesis engine.

FIG. 3 illustrates an example of a process for generating prompts using the language synthesis engine system.

FIG. 4 is a flowchart of an example process associated with perplexity-based prompt generation for communication styles.

FIG. 5 is a flowchart of an example process associated with perplexity-based prompt generation for communication styles.

FIG. 6 is a flowchart of an example process associated with perplexity-based prompt generation for communication styles.

### DETAILED DESCRIPTION

The following detailed description of example implementations refers to the accompanying drawings. The same reference numbers in different drawings may identify the same or similar elements.

According to an aspect, a computer-implemented method may include generating, based on different large-language models (LLMs), prompts that are diverse. The method may include adjusting a level of perplexity in the generated prompts to correspond to one or more communication styles of a target population. By using different LLMs, the system can generate a wide range of prompts that can cater to various communication styles, language patterns, and preferences of the target population. This diversity in prompt generation can lead to more effective and engaging interactions with the target audience. The system's ability to adjust the level of perplexity in the generated prompts enables it to tailor the language complexity and clarity to the specific needs of the target population. By generating prompts that are tailored to the target population's communication style and perplexity level, the system reduces the computational overhead associated with processing and analyzing user responses. The system can more quickly and accurately understand user input, reducing the need for additional processing and re-processing of data.

In one or more embodiments, the method includes applying a psycholinguistic filter that filters communication styles that are different than the one or more communication styles of the target population. The psycholinguistic filter ensures that the generated prompts are more accurately matched to the target population's communication style, reducing the likelihood of miscommunication or confusion. The psycholinguistic filtering reduces the number of prompts that need to be processed and analyzed, conserving computational resources and improving the overall efficiency of the system.

In one or more embodiments, the psycholinguistic filter uses Latent Semantic Analysis (LSA) or machine learning classifiers to measure semantic coherence and linguistic features of the prompts. In this way, high quality content is provided that reduces the number of prompt and response iterations, which conserves processing resources.

In one or more embodiments, the adjusting of the level of perplexity comprises adjusting the level of perplexity based on modification of one or more parameters of the different LLMs. In this way, the responses are understood more clearly. As a result, the number of prompt and response iterations are reduced, which conserves processing resources.

In one or more embodiments, the one or more parameters comprise a temperature. This can be used to control the perplexity level. In this way, the responses are understood more clearly. As a result, the number of prompt and response iterations are reduced, which conserves processing resources.

In one or more embodiments, the one or more parameters comprise a top-k parameter or a top-p parameter. This can be used to control the perplexity level. In this way, the responses are understood more clearly. As a result, the number of prompt and response iterations are reduced, which conserves processing resources.

In one or more embodiments, the adjusting of the level of perplexity comprises adjusting the level of perplexity based on Mirostat sampling of the prompts. This can be used to control the perplexity level. In this way, the responses are understood more clearly. As a result, the number of prompt and response iterations are reduced, which conserves processing resources.

In one or more embodiments, the target population comprises a patient population with a specific medical condition that affects a communication style.

In one or more embodiments, the adjusting of the level of perplexity comprises adjusting the level of perplexity based on patient information, a communication history, and a target perplexity level. This can be used to control the perplexity level. In this way, the responses are understood more clearly. As a result, the number of prompt and response iterations are reduced, which conserves processing resources.

According to an aspect, a computer system may include a processor set, one or more computer-readable storage media, and program instructions stored on the one or more computer-readable storage media to cause the processor set to perform operations. The operations may include generating diverse prompts. The operations may include adjusting a level of perplexity in the diverse prompts to match a communication style of a target patient population. The operations may include filtering the diverse prompts based on a comparison of the diverse prompts to linguistic characteristics of observed patient communications of the target patient population. By generating prompts that are tailored to the target population's communication style and perplexity level, the system reduces the computational overhead associated with processing and analyzing user responses. The system can more quickly and accurately understand user input, reducing the need for additional processing and re-processing of data. The filtering reduces the number of prompts that need to be processed and analyzed, conserving computational resources and improving the overall efficiency of the system.

In one or more embodiments, the level of perplexity corresponds to a complexity of a language of the target patient population. This can be used to control the perplexity level. In this way, the responses are understood more clearly. As a result, the number of prompt and response iterations are reduced, which conserves processing resources.

In one or more embodiments, the operations further comprise analyzing a dataset of patient communications to determine the level of perplexity or communication style characteristics of the target patient population. This can be used to arrive at the appropriate perplexity level quicker. As a result, the number of prompt and response iterations are reduced, which conserves processing resources.

In one or more embodiments, the adjusting of the level of perplexity comprises adjusting the level of perplexity based on temperature scaling, top-k sampling, and top-p sampling to control randomness and diversity of the diverse prompts. This can be used to control the perplexity level. In this way, the responses are understood more clearly. As a result, the number of prompt and response iterations are reduced, which conserves processing resources.

In one or more embodiments, the generating of the diverse prompts comprises generating the diverse prompts based on multiple medical queries by the target patient population in association with a medical condition.

In one or more embodiments, the operations further comprise refining the diverse prompts based on feedback from the adjusting and filtering. This can be used to improve the prompts and response. As a result, the number of prompt and response iterations are reduced, which conserves processing resources.

In one or more embodiments, the operations further comprise: implementing a feedback-loop workflow, where the adjusting and the filtering function as value functions in a reinforcement learning framework; automatically tuning control variables for the adjusting and the filtering based on a quality assessment of the diverse prompts; and iteratively improving prompt generation based on the automatic tuning. This can be used to improve the prompts and response. As a result, the number of prompt and response iterations are reduced, which conserves processing resources.

According to aspect, a computer program product may include one or more computer-readable storage media and program instructions stored on the one or more computer-readable storage media to perform operations. The operations may include receiving a target perplexity value associated with a communication style of a patient population. The operations may include generating diverse and unique prompts using multiple LLMs having a level of perplexity that corresponds to the target perplexity value. The operations may include analyzing the prompts using patient communication datasets and psycholinguistic information of the patient population. By generating prompts that are tailored to the target population's communication style and perplexity level, the system reduces the computational overhead associated with processing and analyzing user responses. The system can more quickly and accurately understand user input, reducing the need for additional processing and re-processing of data. The filtering reduces the number of prompts that need to be processed and analyzed, conserving computational resources and improving the overall efficiency of the system.

In one or more embodiments, the generating of the prompts includes generating the prompts based on a predicted temperature and a predicted set of top candidates and probabilities. This can be used to control the perplexity level. In this way, the responses are understood more clearly. As a result, the number of prompt and response iterations are reduced, which conserves processing resources.

In one or more embodiments, the operations further comprise adjusting the level of perplexity based on a complexity of a medical condition associated with the patient population or one or more language characteristics of the patient population. This can be used to control the perplexity level. In this way, the responses are understood more clearly. As a result, the number of prompt and response iterations are reduced, which conserves processing resources.

In one or more embodiments, the analyzing of the prompts comprises: comparing one or more characteristics of the prompts to a baseline communication pattern; and maintaining a perplexity range and linguistic diversity for the prompts based on the comparing. This can be used to maintain a reasonable perplexity level. As a result, the number of prompt and response iterations are reduced, which conserves processing resources.

Evaluating a medical chatbot involves simulating real-world patient interactions to assess the chatbot’s language understanding, response accuracy, and overall performance. However, existing methods for generating evaluation prompts often fail to capture the complexity and variability of patient communication styles, resulting in limitations in the chatbot’s ability to generalize to diverse patient populations.

A significant challenge in generating effective evaluation prompts is maintaining an appropriate level of perplexity, which measures the difficulty of understanding a sentence or text. Current language models are typically trained to minimize perplexity, resulting in generated text that is often too simplistic or formal to accurately reflect real-world patient interactions.

Furthermore, patient communication styles can vary significantly due to factors such as age, education, language proficiency, and medical conditions. For instance, patients with Alzheimer’s disease or other cognitive impairments may exhibit distinct linguistic patterns, such as reduced vocabulary or sentence complexity, that are not easily captured by traditional prompt generation methods.

Some implementations described herein provide a method for generating prompts that simulate real-world patient interactions to evaluate medical chatbots. For example, a computer system may generate prompts based on different LLMs to produce diverse and representative prompts. The computer system may adjust the level of perplexity in the generated prompts to match the communication styles of a target patient population.

In some aspects, the computer system may also include applying a psycholinguistic filter to analyze the semantic coherence and linguistic features of the prompts and filter out prompts that do not align with the target population’s communication styles. The psycholinguistic filter may use techniques such as Latent Semantic Analysis (LSA) or machine learning classifiers to ensure that the generated prompts are representative and accurate.

In this way, the computer system optimizes the generation of prompts by employing a multi-model approach and fine-tuning perplexity levels to better simulate patient interactions. Additionally, the application of a psycholinguistic filter refines the generated prompts, enhancing their semantic coherence and linguistic accuracy. Consequently, the computer system conserves computing resources, reduces data redundancy, and decreases the need for manual intervention by generating high-quality prompts that accurately reflect the complexity and variability of patient communication styles. In this way, the computer system may conserve processing resources, memory resources, network resources, and/or the like.

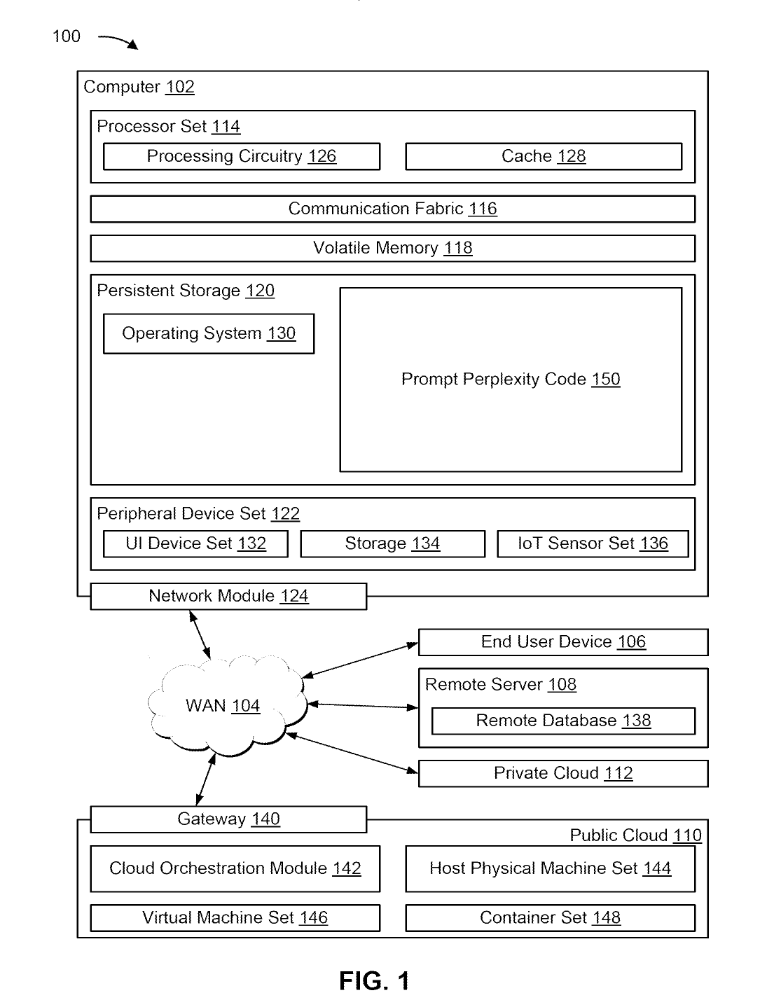

FIG. 1 is a diagram of an example computing environment 100 for adjusting a perplexity of prompts as described herein.

Computing environment 100 contains an example of an environment for the execution of at least some of the computer code involved in performing the inventive methods, such as prompt perplexity code 150. In addition to prompt perplexity code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and prompt perplexity code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one or more computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in prompt perplexity code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

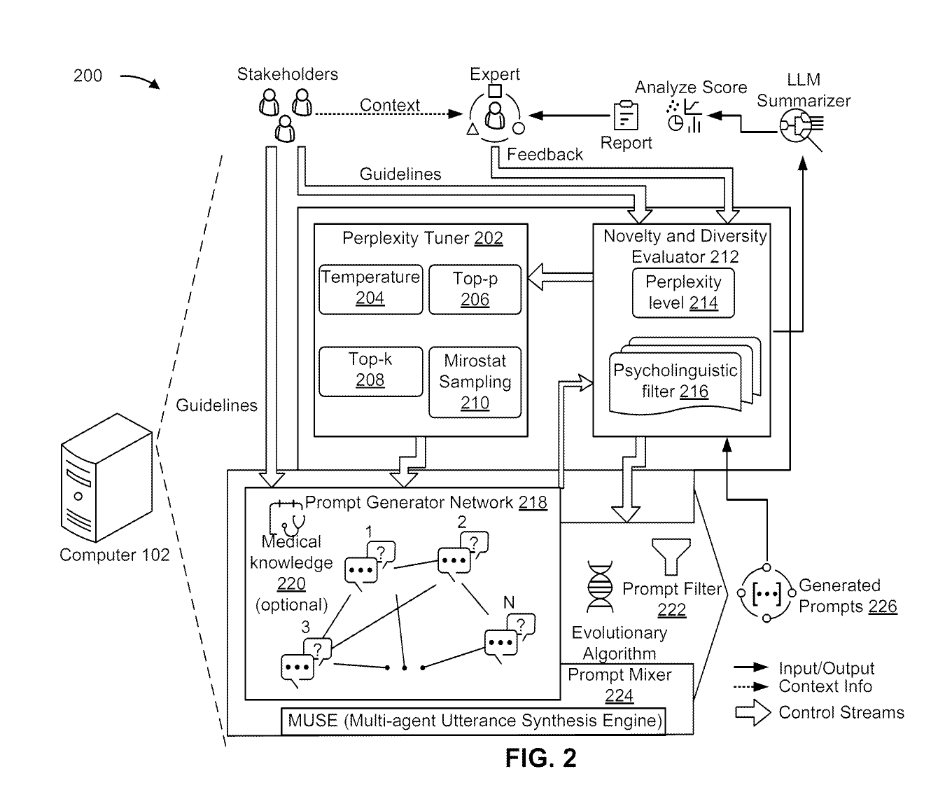

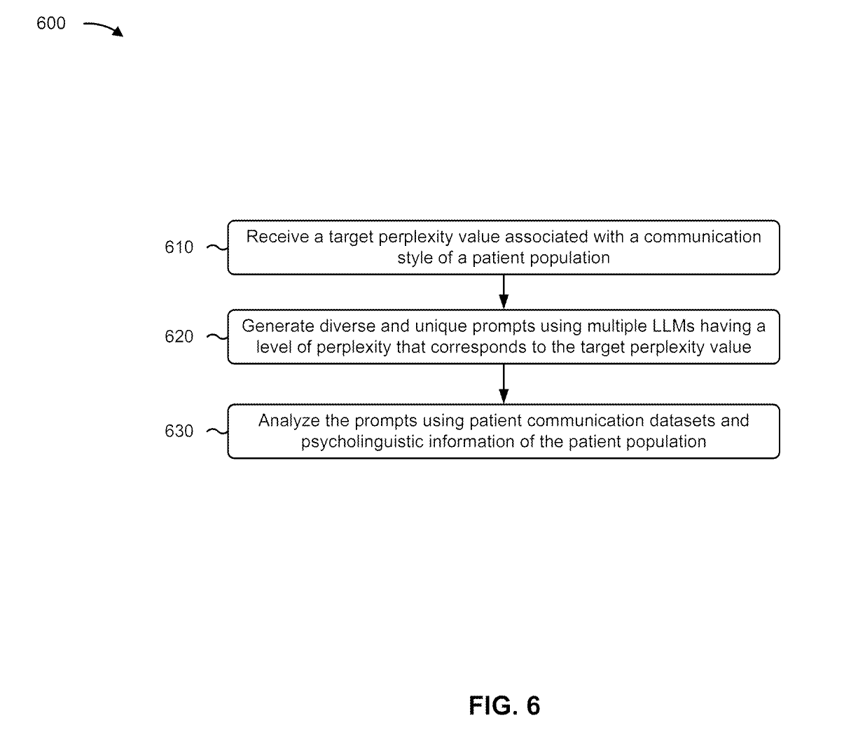

The code included in the prompt perplexity code 150 typically includes at least some of the computer code involved in performing one or more operations described herein, such as the operations of implementation 200 in FIGS. 2, 3-5, and the processes described in FIGS. 6-8.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may generate, based on different large-language models (LLMs), prompts that are diverse. The device may adjust a level of perplexity in the generated prompts to correspond to one or more communication styles of a target population.

In some implementations, the device may adjust a level of perplexity in the diverse prompts to match a communication style of a target patient population. The device may filter the diverse prompts based on a comparison of the diverse prompts to linguistic characteristics of observed patient communications of the target patient population.

In some implementations, the device may receive a target perplexity value associated with a communication style of a patient population. The device may generate diverse and unique prompts using multiple LLMs having a level of perplexity that corresponds to the target perplexity value. The device may analyze the prompts using patient communication datasets and psycholinguistic information of the patient population.

FIG. 2 is a diagram illustrating an implementation 200 of a high-level architecture of a language synthesis engine. A language synthesis engine is a software system designed to generate human-like language outputs, such as text or speech, based on a given input or context. The engine uses a combination of natural language processing (NLP) and machine learning algorithms to produce coherent and accurate language outputs.

Evaluating a medical chatbot involves simulating real-world patient interactions to assess the chatbot’s language understanding, response accuracy, and overall performance. However, existing methods for generating evaluation prompts often fail to capture the complexity and variability of patient communication styles, resulting in limitations in the chatbot’s ability to generalize to diverse patient populations.

A significant challenge in generating effective evaluation prompts is maintaining an appropriate level of perplexity, which measures the difficulty of understanding a sentence or text. Current language models are typically trained to minimize perplexity, resulting in generated text that is often too simplistic or formal to accurately reflect real-world patient interactions.

Furthermore, patient communication styles can vary significantly due to factors such as age, education, language proficiency, and medical conditions. For instance, patients with Alzheimer’s disease or other cognitive impairments may exhibit distinct linguistic patterns, such as reduced vocabulary or sentence complexity, that are not easily captured by traditional prompt generation methods.

In some implementations, a language synthesis engine may be a multi-agent utterance synthesis engine (MUSE) system that involves multiple LLMs. The MUSE system architecture may be designed to efficiently generate prompts for medical chatbot evaluation by combining the capabilities of multiple LLMs with computational psycholinguistic techniques. The system comprises several components that work together to produce novel, diverse, and representative prompts that match communication styles of target patient populations.

Implementation 200 shows a MUSE system for stakeholders that may be a target population, such as patients sharing a medical condition. A computer system (e.g., computer 102) may host and operate the MUSE system. The MUSE system may include multiple components. One component may be a multi-LLM prompt generator, such as prompt generator network 218. Prompt generator network 218 may be a network of different LLMs that generate diverse (varied language and content) and novel (newly-generated) prompts based on input context and parameters. The prompt generator network 218 may leverage the unique capabilities of each LLM to produce a wide range of prompts that test a chatbot’s ability to handle various communication styles and health concerns. In implementation 200, the prompt generator network 218 may include LLMs that are trained with medical knowledge 220.

The generated prompts may have a perplexity level. Perplexity is a measure of how easy or difficult a sentence or text is to understand. In the context of generated prompts 226, perplexity level refers to the degree of complexity or uncertainty in the language used. In some implementations, perplexity levels can be adjusted to match the target patient population’s communication styles, taking into account factors such as language proficiency. Patients with limited language proficiency may require simpler language and shorter sentences. Another factor may be cognitive abilities. For example, patients with cognitive impairments, such as Alzheimer’s disease, may require language that is more concrete and easier to understand. One factor may be a medical condition, as patients with specific medical conditions, such as aphasia, may require language that is tailored to their communication needs. A factor may be a communication style, where patients with different communication styles, such as those who are more direct or indirect, may require language that is adapted to a communication style of the patient.

A perplexity level 214 may be measured using various metrics, such as a perplexity score, which may be a numerical score that represents the complexity of the language used, with higher scores indicating more complex language. Other metrics may include a sentence length, where shorter sentences tend to be easier to understand than longer sentences. Metrics may also include a vocabulary. Using a simpler vocabulary can reduce perplexity, while using a more complex vocabulary can increase the perplexity. Another metric may include syntax. Using simpler sentence structures can reduce perplexity, while using more complex sentence structures can increase perplexity.

Perplexity levels may correspond to numerical values or categories. For example, a low perplexity may involve simple sentences with basic vocabulary and short sentence length, suitable for patients with limited language proficiency or cognitive impairments. An example could be: “What is your name?” A medium perplexity may include sentences with moderate vocabulary and sentence length, suitable for patients with average language proficiency and cognitive abilities. An example could be: “Can you tell me about your symptoms?” A high perplexity may include complex sentences with advanced vocabulary and longer sentence length, suitable for patients with high language proficiency and cognitive abilities. An example could be: “Can you describe the progression of your symptoms over the past week, including any changes in severity or frequency?”

By adjusting the perplexity level of generated prompts, developers can create more effective and engaging interactions with chatbots, tailored to the specific needs and communication styles of the target patient population.

Implementation 200 shows that the system may include a perplexity tuner 202, which may be a module that adjusts the level of perplexity in the generated prompts to match communication styles of target patient populations. The perplexity tuner 202 may use techniques such as temperature scaling, top-k sampling, and top-p sampling to control the randomness and diversity of the generated prompts. The computer system may use a target perplexity level to determine the optimal level of complexity and clarity for the prompts, based on an individual’s needs and abilities.

Top-k sampling 208 is a technique used in NLP to select a subset of words or tokens from a larger set of possibilities. Top-k sampling may be used in language models, such as language generators and chatbots, to generate text that is coherent and natural-sounding. In top-k sampling, the model generates a probability distribution over a set of possible words or tokens, and then selects the top-k words or tokens with the highest probability. The value of k is typically a hyperparameter that is set before training the model. For top-k sampling, the model generates a probability distribution over a set of possible words or tokens. This distribution represents the model’s confidence in each word or token being the next word in the sequence. The model ranks the words or tokens in descending order of their probability. The model selects the top-k words or tokens with the highest probability. The model samples from the selected words or tokens to generate the next word in the sequence. By selecting the top-k words or tokens, the model can generate text that is more coherent and natural-sounding.

Top-p sampling 206 samples from the top p% of the probability distribution, rather than selecting a fixed number of words or tokens. This may include sampling from the nucleus of the probability distribution, which is the region of highest probability density.

In the context of the perplexity tuner, temperature 204 may be a hyperparameter that controls the level of randomness or uncertainty in the generated prompts 226. Temperature is used to adjust the perplexity of the prompts, which is a measure of how easy or difficult a sentence or text is to understand. The temperature parameter is typically set between 0 and 1. For a low temperature (e.g., 0.1), the model may generate prompts that are more deterministic and predictable, with a lower level of randomness and uncertainty. This results in prompts that are more coherent and easier to understand, but may lack diversity and creativity. For a high temperature (e.g., 0.9), the model generates prompts that are more stochastic and unpredictable, with a higher level of randomness and uncertainty. This results in prompts that are more diverse and creative, but may be less coherent and harder to understand.

By adjusting the temperature, the perplexity tuner 202 can control the trade-off between coherence and diversity in the generated prompts. For example, increasing the temperature increases the level of randomness and uncertainty in the generated prompts, resulting in more diverse and creative, but potentially less coherent, prompts. Decreasing the temperature decreases the level of randomness and uncertainty in the generated prompts, resulting in more coherent and predictable, but potentially less diverse, prompts.

The use of temperature in the perplexity tuner has several benefits, including flexibility (allows for adjustable control over the level of randomness and uncertainty in the generated prompts), improved diversity (can generate more diverse and creative prompts by increasing the temperature), and improved coherence (can generate more coherent and predictable prompts by decreasing the temperature).

Additionally, or alternatively, the perplexity tuner 202 may include Mirostat sampling 210 to adjust the level of perplexity. Mirostat sampling is a statistical technique used to adjust the level of perplexity in the generated prompts. This technique involves sampling the prompts to determine the optimal level of perplexity, based on the target population’s communication styles and preferences. By using Mirostat sampling, the computer system may generate prompts that are more effective and engaging for the target population.

The perplexity tuner may be part of a novelty and diversity evaluator 212, which may also include a psycholinguistic filter 216 with psycholinguistic features. The psycholinguistic filter 216 may employ computational psycholinguistic techniques to analyze and compare the generated prompts to real-world patient communication datasets. The psycholinguistic filter 216 may use methods such as Latent Semantic Analysis (LSA) and machine learning classifiers to measure the semantic coherence and linguistic features of the prompts, ensuring their representativeness and coherence.

The psycholinguistic filter 216 may be a component of the language synthesis engine that uses computational psycholinguistic techniques to analyze and compare the generated prompts to real-world patient communication datasets. The psycholinguistic filter 216 may be designed to ensure that the generated prompts are representative and coherent, and align with the communication styles and health concerns of the target patient population.

The psycholinguistic filter 216 may use a range of techniques, including LSA (analyzes the semantic relationships between words and concepts in the generated prompts and the patient communication datasets), machine learning classifiers (datasets to identify patterns and relationships between words, concepts, and communication styles), and NLP to analyze the syntax, semantics, and pragmatics of the generated prompts and the patient communication datasets. In some implementations, the computer system may ensure that the prompts fall within an expected range of perplexity. For example, the computer system may analyze the prompts by comparing one or more characteristics (e.g., communication style, vocabulary, speech length, sentence structure, paragraph structure, word choice, concept coverage, relatedness to content) of the prompts to one or more baseline communication patterns such that the prompts remain within a defined perplexity range while maintaining linguistic diversity. The computer system may maintain the prompt within the perplexity range and maintain a threshold level of linguistic diversity.

The psycholinguistic filter 216 may evaluate the generated prompts based on a range of criteria, including semantic coherence (how well do the prompts align with the meaning and context of the patient communication datasets), linguistic features (how well do the prompts reflect the linguistic features of the patient communication datasets, such as syntax, vocabulary, and tone), or communication style (how well do the prompts align with the communication styles of the target patient population, such as directness, indirectness, or formality).

The psycholinguistic filter 216 may filter out prompts that do not meet the criteria for semantic coherence, linguistic features, and communication style. The psycholinguistic filter 216 may rank prompts based on their alignment with the patient communication datasets and the target patient population. The psycholinguistic filter 216 may also provide feedback to the language synthesis engine to adjust the generated prompts and improve their alignment with the patient communication datasets and the target patient population. The psycholinguistic filter 216 may improve the coherence and relevance of the generated prompts to the target patient population.

The system may also an interface for providing input context and parameters to the MUSE system, such as patient medical records, communication history, and target perplexity levels. This input guides the multi-LLM prompt generator in producing prompts that are relevant and representative of the target patient population.

The final set of generated prompts 226 that have been processed by the perplexity tuner 202 and the psycholinguistic filter 216 are ready for use in evaluating medical chatbots and assessing their performance against a wide range of patient queries and communication styles.

Other components may contribute to the generated prompts 226, including a prompt mixer 224 that mixes or evolves prompts (e.g., using an evolutionary algorithm) and a prompt filter 222 to further filter the prompts based on different factors. Prompts may be scored by the novelty and diversity evaluator 212 or other evaluators, and feedback may be provided to the system.

The implementation of the MUSE system can be achieved using various programming languages and frameworks, depending on the specific requirements and preferences of the development team. The multi-LLM prompt generator may be implemented using state-of-the-art LLMs, such as GPT-3® models, bidirectional encoder representations from transformers (BERT) models, or custom-trained models. The perplexity tuner 202 and the psycholinguistic filter 216 may be developed using standard programming practices and libraries for natural language processing, machine learning, and data analysis.

The computer system may enhance the diversity and novelty of the generated prompts. By leveraging the unique capabilities of different LLMs, the computer system may produce a wide range of prompts that test a chatbot’s ability to handle various communication styles and health concerns. The perplexity tuner allows the system to adjust the level of perplexity in the generated prompts to match communication styles of target patient populations. This ensures that the prompts are representative of real-world patient queries and enables more comprehensive evaluation of chatbots’ performances. The psycholinguistic filter ensures the representativeness and coherence of the generated prompts. By analyzing and comparing the prompts to real-world patient communication datasets, the computer system may select prompts that align with the communication styles and health concerns of target patient populations.

The combination of multiple LLMs and computational psycholinguistic techniques provides a scalable and cost-effective solution for generating high-quality prompts. By automating the prompt generation process and reducing reliance on manual annotation, the computer system may enable efficient evaluation of medical chatbots at a large scale. The ability to generate prompts representative of diverse patient populations promotes the development of inclusive and equitable chatbot systems. By ensuring that chatbots are evaluated against a broad spectrum of communication styles and health concerns, MUSE contributes to reducing disparities in access to reliable health information.

Additionally, or alternatively, the computer system may use prompt perplexity code to refine prompts based on feedback. The feedback may be used to adjust the level of perplexity, clarity, and relevance of the prompts, ensuring that they are more effective and engaging for the target population. This iterative process enables the computer system to continuously improve and adapt to the needs of the target population.

Additionally, or alternatively, the prompt perplexity code may include predicted temperature and top candidates and probabilities to generate prompts. For example, the predicted temperature is used to control the randomness of the prompts, while the top candidates and probabilities are used to achieve a target perplexity level.

The computer system may implement the MUSE system in different embodiments. For example, the system may be a standalone prompt generation platform that allows chatbot developers, researchers, and other stakeholders to input context and parameters, such as patient medical records and target perplexity levels, and receive a set of novel, diverse, and representative prompts for evaluating their chatbots. The computer system may integrate the MUSE system with an existing chatbot development framework. Chatbot developers may leverage the MUSE system capabilities within a preferred development environment, enhancing the quality and representativeness of their chatbot evaluation prompts.

In some implementations, the MUSE system may be offered as a cloud-based application programing interface (API) service that allows developers and researchers to generate prompts for medical chatbot evaluation programmatically. The API can provide a simple and flexible interface for submitting context and parameters and receiving a set of generated prompts in return. This may enable easy integration of MUSE into various chatbot development and evaluation workflows.

In some implementations, the MUSE system may be used as a research tool or a customizable prompt generation service for organizations and individuals with specific requirements for medical chatbot evaluation. The service may allow users to fine-tune the system’s parameters, such as the choice of LLMs, perplexity levels, and psycholinguistic analysis techniques, to better suit their unique evaluation needs.

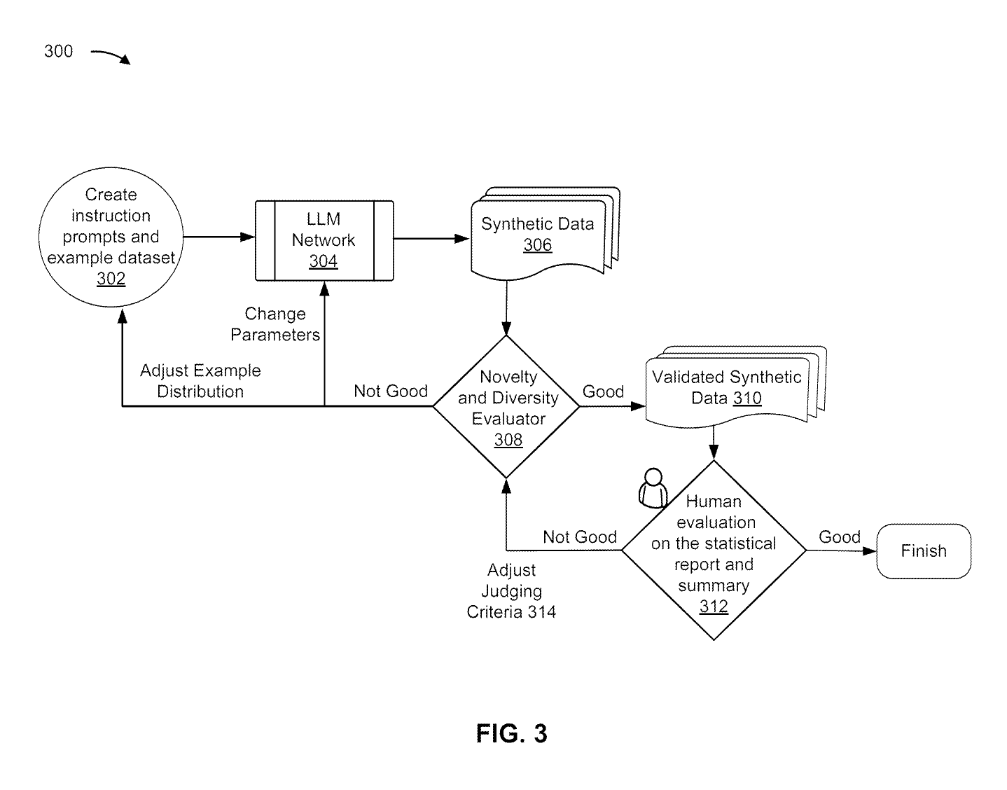

FIG. 3 illustrates an example of a process for generating prompts using the MUSE system. As shown by reference number 302, initially, a computer system (e.g., computer 102) may generate instruction prompts and example data sets, utilizing different LLMs to create diverse prompts. The prompts may be input into the LLM network 304, which uses multiple different LLMs to produce diverse prompts having a level of perplexity that may, or may not, correspond to a target population. The diverse prompts may be synthetic or synthesized data 306. The system may adjust the level of perplexity to match the communication style of the target patient population, if necessary. This adjustment may be facilitated through Mirostat sampling of the prompts. Notably, the system does not generate good or bad prompts, but rather, human evaluators may assess the prompts based on criteria, such as complexity, diversity, and novelty, and assign them a “good” or “not good” label, which may be used to filter the prompts further. Prompts with a “good” label may become validated synthetic or synthesized data 310 that is input into the novelty and diversity evaluator 308, which is similar to the novelty and diversity evaluator 212 of FIG. 2. For “not good” labels, the computer system may change parameters or adjust a distribution of the prompts.

As shown by reference number 312, there may be a manual evaluation (e.g., by a user of the MUSE system). For “not good” labels, the computer system may adjust judging criteria, as shown by reference number 314.

For example, the MUSE system may operate in a feedback-loop workflow mode. The MUSE system may be trained to improve its performance over time. The perplexity tuner 202 and the psycholinguistic filter 216 may function as value functions in a reinforcement learning framework. These two components (or value functions) may automatically check the quality of the synthetic output and remove the low quality output (e.g., below a quality threshold). The two components may also auto-tune the control variables to improve the quality of the synthetic output, which reassembles the reinforcement learning mechanism. The user of the MUSE system may wait until the performance of the MUSE system converges to check the output quality. In this way. the user does not need to manually check each output to decide whether the output meets the requirements and then adjust the control variables. As a result, the optimization efficiency and output quality of the MUSE system improves.

The process of obtaining the validated synthetic data 310 may involve generating prompts using a perplexity tuner, such as the perplexity tuner 202 of FIG. 2. For example, the perplexity tuner may be used to adjust the level of perplexity to match the target patient population. By tuning the perplexity level, the system can generate prompts that are more representative of a patient’s language style, taking into account factors such as education level, medical condition, and language proficiency.

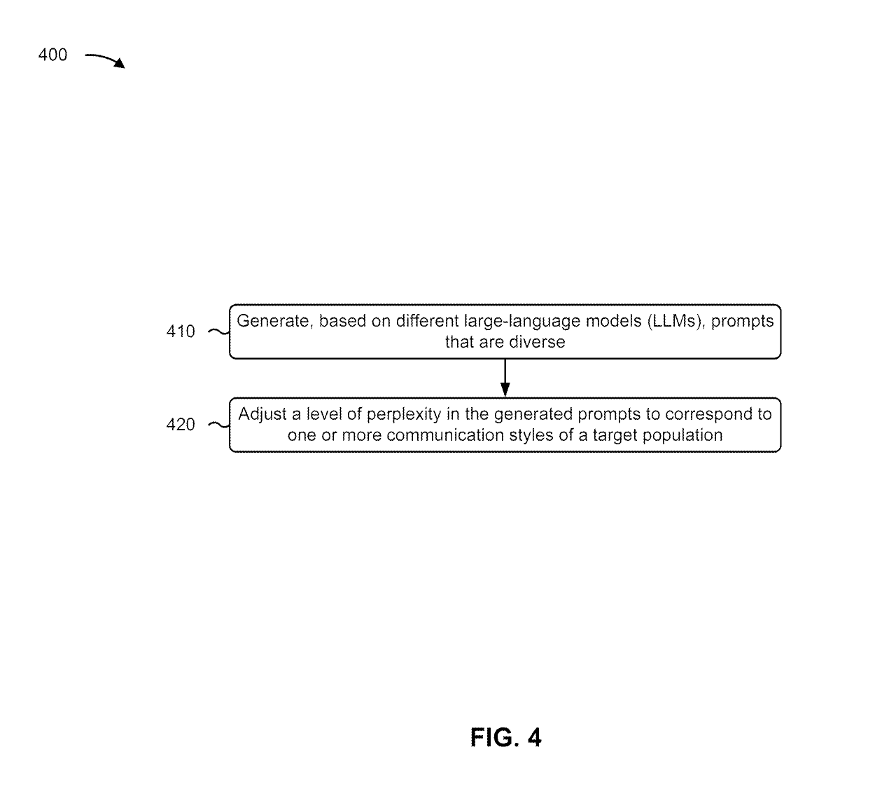

FIG. 4 is a flowchart of an example process 400 associated with perplexity-based prompt generation for communication styles. One or more process blocks of FIG. 4 are performed by a computer system (e.g., computer 102) and/or by another device or a group of devices separate from or including the computer system.

As shown in FIG. 4, process 400 includes generating, based on different LLMs, prompts that are diverse (block 410). For example, the computer system may generate, based on different LLMs, prompts that are diverse, as described above.

As further shown in FIG. 4, process 400 includes adjusting a level of perplexity in the generated prompts to correspond to one or more communication styles of a target population (block 420). For example, the computer system may adjust a level of perplexity in the generated prompts to correspond to one or more communication styles of a target population, as described above.

Process 400 may include additional aspects, such as any single aspect or any combination of aspects described below and/or in connection with one or more other processes described elsewhere herein.

In a first aspect, process 400 includes applying a psycholinguistic filter that filters communication styles that are different than the one or more communication styles of the target population.

In a second aspect, alone or in combination with the first aspect, the psycholinguistic filter uses LSA or machine learning classifiers to measure semantic coherence and linguistic features of the prompts.

In a third aspect, alone or in combination with one or more of the first and second aspects, the adjusting of the level of perplexity comprises adjusting the level of perplexity based on modification of one or more parameters of the different LLMs.

In a fourth aspect, alone or in combination with one or more of the first through third aspects, the one or more parameters comprise a temperature.

In a fifth aspect, alone or in combination with one or more of the first through fourth aspects, the one or more parameters comprise a top-k parameter or a top-p parameter.

In a sixth aspect, alone or in combination with one or more of the first through fifth aspects, the adjusting of the level of perplexity comprises adjusting the level of perplexity based on Mirostat sampling of the prompts.

In a seventh aspect, alone or in combination with one or more of the first through sixth aspects, the target population comprises a patient population with a specific medical condition that affects a communication style.

In an eighth aspect, alone or in combination with one or more of the first through seventh aspects, the adjusting of the level of perplexity comprises adjusting the level of perplexity based on patient information, a communication history, and a target perplexity level.

In a ninth aspect, alone or in combination with one or more of the first through eighth aspects, process 400 includes implementing a feedback-loop workflow, where the adjusting and the filtering function as value functions in a reinforcement learning framework; automatically tuning control variables for the adjusting and the filtering based on a quality assessment of the diverse prompts; and iteratively improving prompt generation based on the automatic tuning.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

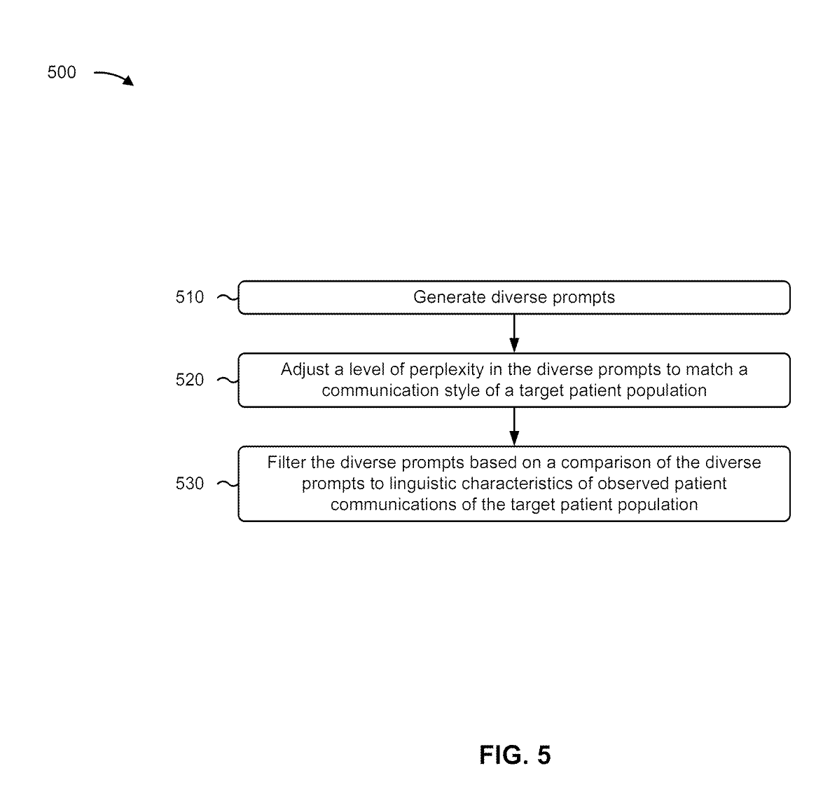

FIG. 5 is a flowchart of an example process 500 associated with perplexity-based prompt generation for communication styles. One or more process blocks of FIG. 5 are performed by a computer system (e.g., computer 102) and/or by another device or a group of devices separate from or including the computer system.

As shown in FIG. 5, process 500 includes generating diverse prompts (block 510). For example, the computer system may generate diverse prompts, as described above.

As further shown in FIG. 5, process 500 includes adjusting a level of perplexity in the diverse prompts to match a communication style of a target patient population (block 520). For example, the computer system may adjust a level of perplexity in the diverse prompts to match a communication style of a target patient population, as described above.

As further shown in FIG. 5, process 500 includes filtering the diverse prompts based on a comparison of the diverse prompts to linguistic characteristics of observed patient communications of the target patient population (block 530). For example, the computer system may filter the diverse prompts based on a comparison of the diverse prompts to linguistic characteristics of observed patient communications of the target patient population, as described above.

Process 500 may include additional aspects, such as any single aspect or any combination of aspects described below and/or in connection with one or more other processes described elsewhere herein.

In a first aspect, the level of perplexity corresponds to a complexity of a language of the target patient population.

In a second aspect, alone or in combination with the first aspect, the operations further comprise analyzing a dataset of patient communication to determine the level of perplexity.

In a third aspect, alone or in combination with one or more of the first and second aspects, the operations further comprise analyzing a dataset of patient communications to determine communication style characteristics of the target patient population.

In a fourth aspect, alone or in combination with one or more of the first through third aspects, the adjusting of the level of perplexity comprises adjusting the level of perplexity based on temperature scaling, top-k sampling, and top-p sampling to control randomness and diversity of the diverse prompts.

In a fifth aspect, alone or in combination with one or more of the first through fourth aspects, the generating of the diverse prompts comprises generating the diverse prompts based on multiple medical queries by the target patient population in association with a medical condition.

In a sixth aspect, alone or in combination with one or more of the first through fifth aspects, the diverse prompts are based on feedback from the adjusting and filtering.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

FIG. 6 is a flowchart of an example process 600 associated with perplexity-based prompt generation for communication styles. One or more process blocks of FIG. 6 are performed by a computer system (e.g., computer 102) and/or by another device or a group of devices separate from or including the computer system.

As shown in FIG. 6, process 600 includes receiving a target perplexity value associated with a communication style of a patient population (block 610). For example, the computer system may receive a target perplexity value associated with a communication style of a patient population, as described above.

As further shown in FIG. 6, process 600 includes generating diverse and unique prompts using multiple LLMs having a level of perplexity that corresponds to the target perplexity value (block 620). For example, the computer system may generate diverse and unique prompts using multiple LLMs having a level of perplexity that corresponds to the target perplexity value, as described above.

As further shown in FIG. 6, process 600 includes analyzing the prompts using patient communication datasets and psycholinguistic information of the patient population (block 630). For example, the computer system may analyze the prompts using patient communication datasets and psycholinguistic information of the patient population, as described above.

Process 600 may include additional aspects, such as any single aspect or any combination of aspects described below and/or in connection with one or more other processes described elsewhere herein.

In a first aspect, the generating of the prompts includes generating the prompts based on a predicted temperature and a predicted set of top candidates and probabilities.

In a second aspect, alone or in combination with the first aspect, the operations further comprise adjusting the level of perplexity based on a complexity of a medical condition associated with the patient population.

In a third aspect, alone or in combination with one or more of the first and second aspects, the operations further comprise adjusting the level of perplexity based on one or more language characteristics of the patient population.

In a fourth aspect, alone or in combination with one or more of the first through third aspects, the analyzing of the prompts comprises comparing one or more characteristics of the prompts to one or more baseline communication patterns such that the prompts remain within a defined perplexity range while maintaining linguistic diversity. This may include maintaining a perplexity range and linguistic diversity for the prompts based on the comparison.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
generating, based on different large-language models (LLMs), prompts that are diverse; and
adjusting a level of perplexity in the generated prompts to correspond to one or more communication styles of a target population.

2. The method of claim 1, further comprising applying a psycholinguistic filter that filters communication styles that are different than the one or more communication styles of the target population.

3. The method of claim 2, wherein the psycholinguistic filter uses Latent Semantic Analysis (LSA) or machine learning classifiers to measure semantic coherence and linguistic features of the prompts.

4. The method of claim 1, wherein the adjusting of the level of perplexity comprises adjusting the level of perplexity based on modification of one or more parameters of the different LLMs.

5. The method of claim 4, wherein the one or more parameters comprise a temperature.

6. The method of claim 4, wherein the one or more parameters comprise a top-k parameter or a top-p parameter.

7. The method of claim 4, wherein the adjusting of the level of perplexity comprises adjusting the level of perplexity based on Mirostat sampling of the prompts.

8. The method of claim 1, wherein the target population comprises a patient population with a specific medical condition that affects a communication style.

9. The method of claim 1, wherein the adjusting of the level of perplexity comprises adjusting the level of perplexity based on patient information, a communication history, and a target perplexity level.

10. A computer system comprising:
a processor set;
one or more computer-readable storage media; and
program instructions stored on the one or more computer-readable storage media to cause the processor set to perform operations comprising:
generating diverse prompts;
adjusting a level of perplexity in the diverse prompts to match a communication style of a target patient population; and
filtering the diverse prompts based on a comparison of the diverse prompts to linguistic characteristics of observed patient communications of the target patient population.

11. The computer system of claim 10, wherein the level of perplexity corresponds to a complexity of a language of the target patient population.

12. The computer system of claim 10, wherein the operations further comprise analyzing a dataset of patient communications to determine the level of perplexity or communication style characteristics of the target patient population.

13. The computer system of claim 10, wherein the adjusting of the level of perplexity comprises adjusting the level of perplexity based on temperature scaling, top-k sampling, and top-p sampling to control randomness and diversity of the diverse prompts.

14. The computer system of claim 10, wherein the generating of the diverse prompts comprises generating the diverse prompts based on multiple medical queries by the target patient population in association with a medical condition.

15. The computer system of claim 10, wherein the operations further comprise refining the diverse prompts based on feedback from the adjusting and filtering.

16. The computer system of claim 10, wherein the operations further comprise:
implementing a feedback-loop workflow, wherein the adjusting and the filtering function as value functions in a reinforcement learning framework;
automatically tuning control variables for the adjusting and the filtering based on a quality assessment of the diverse prompts; and
iteratively improving prompt generation based on the automatic tuning.

17. A computer program product comprising:
one or more computer-readable storage media; and
program instructions stored on the one or more computer-readable storage media to perform operations comprising:
receiving a target perplexity value associated with a communication style of a patient population;
generating diverse and unique prompts using multiple large language models (LLMs) having a level of perplexity that corresponds to the target perplexity value; and
analyzing the prompts using patient communication datasets and psycholinguistic information of the patient population.

18. The computer program product of claim 17, wherein the generating of the prompts includes generating the prompts based on a predicted temperature and a predicted set of top candidates and probabilities.

19. The computer program product of claim 17, wherein the operations further comprise adjusting the level of perplexity based on a complexity of a medical condition associated with the patient population or one or more language characteristics of the patient population.

20. The computer program product of claim 17, wherein the analyzing of the prompts comprises:
comparing one or more characteristics of the prompts to a baseline communication pattern; and
maintaining a perplexity range and linguistic diversity for the prompts based on the comparing.
